(19) United States
(12) Patent Application Publication
(10) Pub. No.: US 2006/0183086 A1
(43) Pub. Date: Aug. 17, 2006

(54) Feeding implements for children of different stages of development

(76) Inventor: Thorsten Brandt, Geneva (CH)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/047,097

(22) Filed: Jan. 31, 2005

(51) Int. Cl. G09B 19/00

(52) U.S. Cl. 434/127

(57) ABSTRACT

An array of feeding implement products including a first feeding implement adapted for use during a first stage of development, a first package enclosing the first feeding implement, and a first pictorial representation disposed on the first package. The first pictorial representation depicts the first feeding implement, a caregiver, and a first baby, wherein the first baby is represented as corresponding to the first stage of development. The array further includes a second feeding implement adapted for use during a second stage of development, a second package enclosing the second feeding implement, and a second pictorial representation disposed on the second package. The second pictorial representation depicts the second feeding implement, a caregiver, and a second baby, wherein the second baby is represented as corresponding to the second stage of development.

### FIELD OF THE INVENTION

The present disclosure generally relates to feeding implements for children and, more particularly, to the use of pictorial representations to assist selection by a consumer of feeding implements suitable for his or her child.

### BACKGROUND OF THE INVENTION

The development of babies and young children is complex and multi-faceted. As a child matures from infancy to young childhood and beyond, he or she will experience physical, physiological, psychological, emotional, and other areas of development. The rate of development in these various aspects is different for each child, and therefore children of similar ages may have varied skill sets.

Manufacturers of products designed for babies and small children have long recognized the need to tailor their products to specific stages of child development. Accordingly, certain products have been offered in several versions, such as different sizes, to accommodate children in different stages of development. While size is of particular concern, the variations in a product line may take into account different or additional aspects of child development. For example, obvious benefits are recognized by providing diapers in various sizes. It is even more advantageous, however, to consider additional aspects such as physiological development when designing diapers for different stages of development. Newborns, for example, are relatively immobile and therefore diapers designed for newborns need not facilitate movement of the baby. By contrast, toddlers are typically able to crawl or walk, and therefore diapers intended for use by toddlers should also consider mobility as a design component. In addition to diapers, the design of product lines for wipes, bibs, feeding implements, bath care items, personal hygiene products, and other baby care articles may also take into consideration multiple aspects of child development.

While manufactures have recognized the need to provide products specifically adapted for various stages of child development, it has proven difficult to communicate these stages to the consumer and to clearly identify products as suitable for a particular developmental stage. Because of these difficulties, manufacturers have typically identified suitability of a product by noting an age or range of ages. Because children develop at different rates, however, this approach may result in inappropriate purchasing decisions by a consumer. Furthermore, there is a risk that the age-based system may be interpreted by a parent as a baseline or standard for child development. Consequently, the age-based approach may generate or exacerbate a parent's anxiety should his or her child meet the requisite age but prove incapable of properly using the product.

### BRIEF DESCRIPTION OF THE DRAWINGS

FIG. 1 illustrates a feeding implement suitable for a first stage of child development;

FIGS. 2A and 2B illustrate feeding implements suitable for use during a second stage of child development;

FIGS. 3A and 3B illustrate feeding implements suitable for use during a third stage of child development;

FIGS. 4A, 4B, and 4C illustrate pictorial representations to be associated with feeding implements for use during first, second, and third stages of development, respectively;

FIGS. 5A and 5B illustrate pictorial representations to be associated with feeding implements for use during two different stages of baby development;

FIGS. 6A, 6B, and 6C illustrate first, second, and third arrays of pictorial representations to be associated with baby care articles suitable for use during first, second, and third stages of development, respectively;

FIG. 7 illustrates an array of background color schemes which may be used in pictorial representations to indicate a particular stage of child development;

FIGS. 8A, 8B, and 8C illustrate arrays of pictorial representations in which one pictorial representation is enlarged to highlight a particular baby stage of development;

FIG. 9 illustrates a retail display in which baby care articles may be organized by the stage of development for which the products are appropriate.

### DETAILED DESCRIPTION OF THE INVENTION

The present disclosure is directed to apparatus and methods of marking, identifying, and displaying baby care articles according to stages of baby development. Certain exemplary embodiments use pictorial representations on packaging for feeding implements, wherein the pictorial representations are associated with specific stages of child development and are easily identified as such by a consumer. Other exemplary embodiments disclose the use of similar or otherwise consistent pictorial representations on various types of baby care articles intended for the same stage of child development. For example, diapers, wipes, bibs, feeding implements, bath care items, personal hygiene products, and other types of baby care articles all intended for a specific stage of baby development may carry pictorial representations selected from a set of pictorial representations having a common visual element, thereby to allow a consumer to more readily identify a product as appropriate for his or her own child. A further exemplary embodiment of a retail display is disclosed, in which baby care articles may be arranged according to different stages of child development thereby to more readily direct the consumer to the appropriate area of the display.

As used herein, the term “pictorial representation” refers to any type of identifying marking, which may include words and/or graphics depicting a baby care article. As explained in greater detail below, the graphics may include images of one or more caregiver, baby, baby care article, or other object, and may incorporate colors, shading, icons, or other features. The pictorial representation may be provided directly on the baby care article, on packaging for the article, on literature enclosed with or attached to the article or its packaging, or may be otherwise associated with the article.

As used herein, the term “baby care article” refers to devices or products designed for babies or small children. Exemplary types of baby care articles include, but are not limited to, diapers, wipes, bibs, feeding implements, bath care items, and personal hygiene products.

As used herein, the term “caregiver” means a person other than the child, such as, a parent, babysitter, family member, teacher, day care worker, or other person who is able to provide sufficient assistance or supervision to a child using a baby care article.

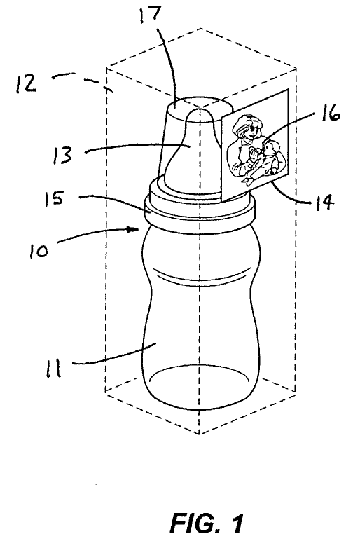

Various exemplary feeding implements disposed in packages bearing pictorial representations indicating a corresponding stage of child development are illustrated in FIGS., 1, 2A, 2B, 3A, 3B. FIG. 1 shows a first feeding implement in the form of a baby bottle 10 enclosed in a first package 12. The baby bottle 10 includes a base 11, nipple 13, collar 15, and cap 17. The package 12 includes a label 14 bearing a pictorial representation 16 depicting use of the bottle 10 by a child in a first stage of development.

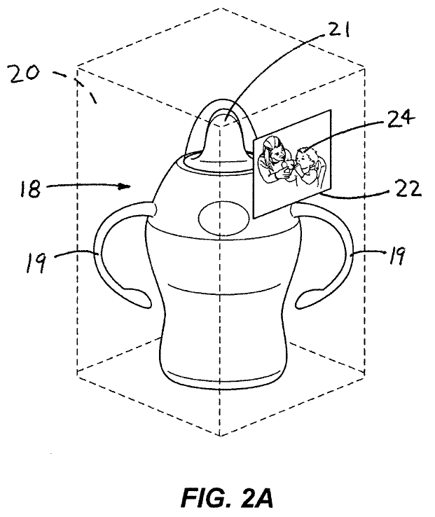

FIGS. 2A and 2B illustrate feeding implements suitable for use in a second stage of child development. FIG. 2A illustrates a training cup 18 enclosed in a package 20 having a label 22. The training cup 18 includes two handles 19 and a nipple-like valve 21 for regulating fluid flow therethrough. The handles 19 are sized for grasping by a child having limited or coarse motor skills. The label 22 includes a pictorial representation 24 which depicts use of the cup 18 by a child in the second stage of development. FIG. 2B illustrates a bowl 26 and spoon 28 enclosed in a package 30. The bowl 26 includes a side hand grip 27 and two receptacles 29. The spoon 28 has a relatively thin handle 31 and a head 33 sized for insertion into a child's mouth. The bowl 36 and spoon 38 are intended to be manipulated primarily be a caregiver. The package 30 includes a label 32 bearing a pictorial representation 34 depicting use of the bowl 26 and spoon 28 by a child in the second stage of development.

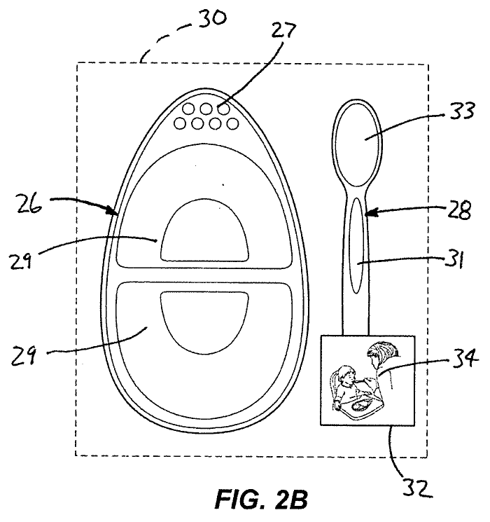

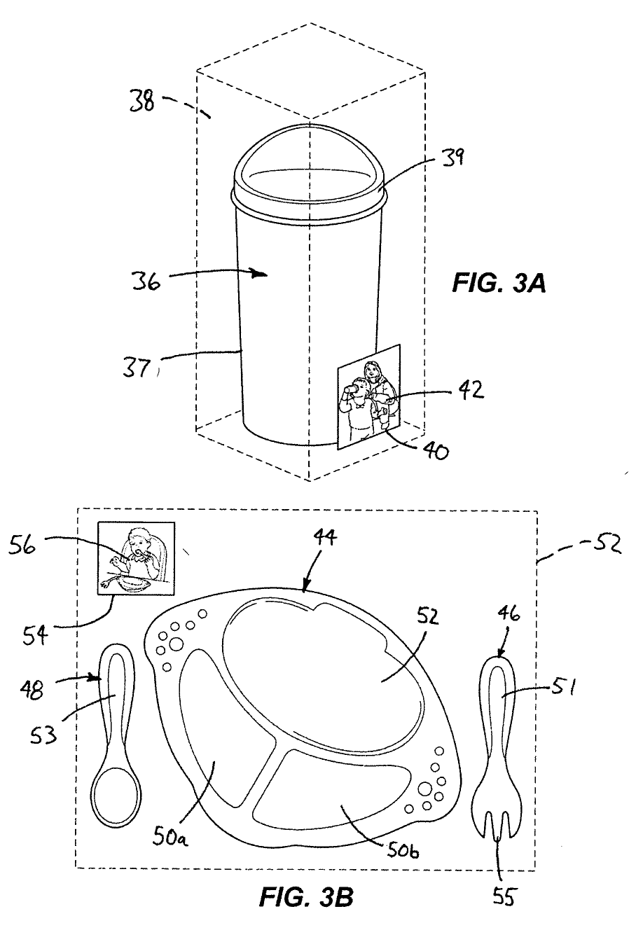

FIGS. 3A and 3B illustrate feeding implements suitable for use during a third stage of child development. FIG. 3A illustrates a sippy cup 36 enclosed in a package 38 having a label 40. The sippy cup 36 has a handle-less base 37 sized for manipulation by a child having more advanced motor skills and a removable lid 39. The label 40 includes a pictorial representation 42 which depicts use of the cup 36 by a child in the third stage of development. FIG. 3B illustrates a training bowl 44, training fork 46, and training spoon 48. The bowl 44 includes a segmented recess defining open bowl sections 50a, 50b and a moveable cover 52 for enclosing a covered bowl section (not shown). The fork 46 and spoon 48 have oversized handles 51, 53 suited for gripping by a child. The fork 48 further has tines 55 with rounded points to minimize risk of injury to the child during use. The bowl 44, fork 46, and spoon 48 are enclosed in a package 52 having a label 54. The label 54 includes a pictorial representation 56 which depicts use of the bowl 44, fork 46, and spoon 48 by a child in the third stage of development.

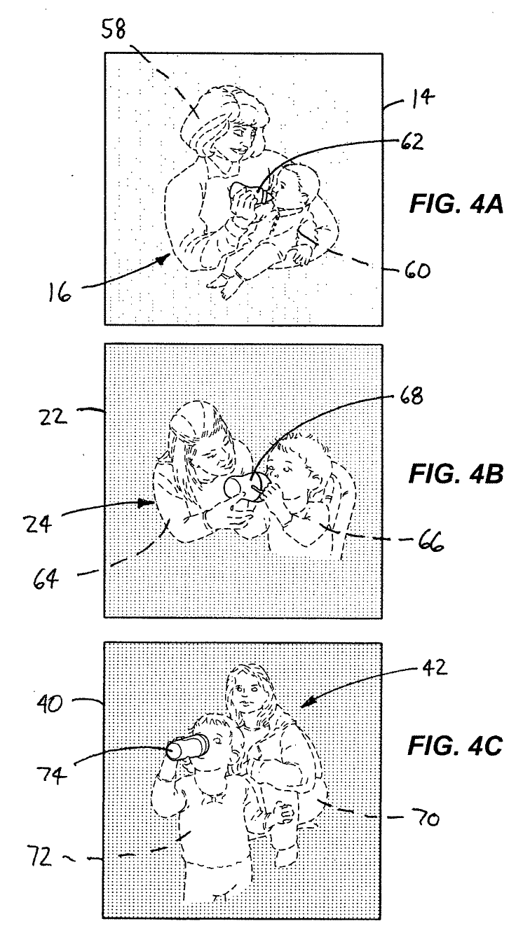

The pictorial representations 16, 24, 34, 42, and 56 include graphic or text features which communicate an associated stage of baby development for which the product is appropriate. As shown in greater detail in FIG. 4A, the pictorial representation 16 of label 14 includes an image 58 of a caregiver, an image 60 of a newborn, and an image 62 of the baby bottle. The caregiver is depicted supporting the newborn upright with one arm and holding the baby bottle in her hand to feed the child. This image conveys that the product, in this instance the baby bottle, is intended for use with a child that requires a large degree of assistance from a caregiver, which may correspond to a first baby stage of development.

The pictorial representation 24 of label 22 may communicate use of the training cup 18 by a child in a second stage of baby development. As shown in greater detail in FIG. 4B, the pictorial representation 24 includes an image 64 of a caregiver, and image 66 of an infant, and an image 68 of the training cup. The infant is depicted as sitting in a chair and holding the training cup while the caregiver is nearby, providing more limited assistance. In contrast with the message conveyed by the pictorial representation 16, the pictorial representation 24 conveys to a consumer that the training cup is intended for use by a child having at least a limited degree of independence and physical motor skills, which may correspond to a second stage of baby development.

The pictorial representation 42 provided on label 40 may communicate use of the sippy cup 36 by a child in a third stage of baby development. As best shown in FIG. 4C, the pictorial representation 34 includes an image 70 of a caregiver, an image 72 of a toddler, and an image 74 of a sippy cup. The toddler is depicted as standing on her own while holding the sippy cup in one hand, while the caregiver supervises from a remote location. The toddler illustrated in the pictorial representation 34 clearly has more advanced motor skills and more independence than the infant illustrated in pictorial representation 24. Accordingly, the message conveyed to a consumer is that the sippy cup is intended for a child of more advanced physiological makeup and physical skills, which may correspond to the third baby stage of development.

The pictorial representation 34 of label 32 may communicate use of the bowl 26 and spoon 28 by a child in the second stage of baby development noted above with respect to FIG. 4B. The pictorial representation 42 includes an image 76 of a caregiver, an image 78 of an infant, an image 80 of a bowl, and an image 82 of a spoon. The infant is depicted as seated in a highchair having a tray, with the bowl resting on top of the tray. The caregiver is shown using the spoon to feed the infant. Accordingly, the infant depicted in the pictorial representation 34 is capable of eating solids, and therefore, more advanced than the newborn illustrated in pictorial representation 16, but does not possess sufficient motor skills to independently feed herself. Accordingly, the infant is at a stage of development in which it requires some assistance from the caregiver, similar to the second baby stage of development noted above.

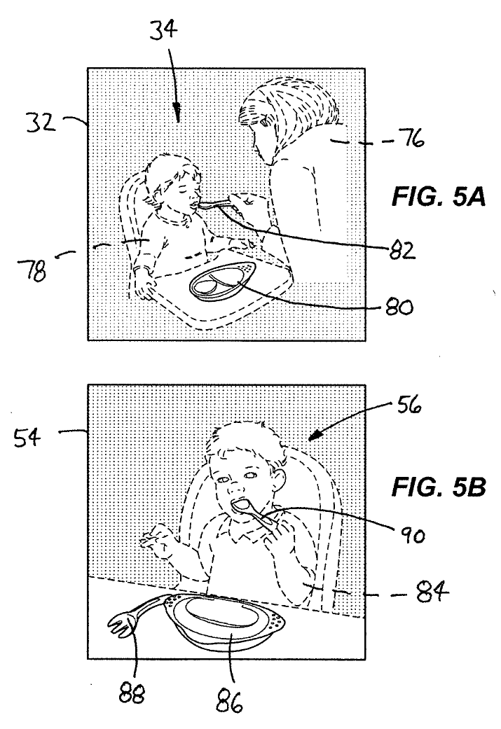

The pictorial representation 56 of label 54 may correspond to the third stage of baby development. As best illustrated with reference to FIG. 5B, the pictorial representation 56 includes an image of a toddler 84, an image of a training bowl 86, an image of a training fork 88, and an image of a training spoon 90. The toddler is shown seated at a table on which the training bowl and training fork rests and is using the training spoon to feed himself. Significantly, no image of a caregiver is included in pictorial representation 42, and therefore the toddler possesses skills sufficient to feed himself independent of the caregiver. Accordingly, a consumer may understand from pictorial representation 56 that the training bowl 44, training fork 46, and training spoon 48 are intended for a child having a certain degree of independence, which may correspond to third stage of baby development noted above.

As noted above, the first stage of baby development has been described as generally corresponding to the newborn stage, the second stage of baby development to the infant stage, and the third stage of baby development to the toddler stage. These names for the stages are not intended to imply a specific age or range of ages, but instead to correspond to the abilities of a child. Other terms may be used to identify the stages of development that are less likely to imply age. For example, the first stage of development may correspond to a reflexive stage, where the child requires full assistance during feeding. In this stage, the child may lack sufficient motor skills to use a feeding implement independently and may have a limited level of physiological development that requires a liquid diet. The second stage of baby development may correspond to a coarse motor skills stage in which the child is physically and mentally able to perform some feeding activities but may still require some assistance from a caregiver. In this stage, the child may be capable of grasping large handles on training cups or training implements. The third stage of baby development may correspond to a fine motor skills stage in which the child is generally capable of performing all functions required during feeding and therefore needs little or no assistance from a caregiver. In this stage, the child may be capable of grasping a sippy cup without a handle and manipulating training implements.

To this point, the stages of baby development have been described with reference to the physiological traits and motor skills possessed by the child. It is possible, however, to define stage of development with respect to other aspects of child development, such as emotional or mental capabilities. In general, regardless of the factors considered, discrete stages of development may be associated with transition moments that are easily recognized by a caregiver. Such transition moments may include a child's ability to perform a new physical activity or motion, a new physiological trait exhibited by the child, demonstration of a new mental of emotional ability, or other new capability exhibited by the child.

Furthermore, while the exemplary embodiments identify three stages of development, certain baby care articles may require only two or more than three levels of distinction, and may define these stages according to different parameters of child development. For example, a first stage of development might cover a growing or pre-locomotive phase and include newborns in a bonding stage with mom and other immobile infants whose level of activity may include little more than head raising or rolling over. A second stage of development might cover a discovering stage comprising a crawling phase and including curious toddlers developing activity in the form of sitting and mobility in the form of scooting, rolling, or crawling. A third stage of development may cover an exploring stage comprising a walking phase and include toddlers whose level of activity includes standing, walking, and beginning to run. A fourth stage of development might cover a learning phase an include toddlers being capable of doing things by themselves, such as dressing and developing coordination which enables them to walk and run without losing balance. This fourth stage might also focus on training and include toddlers under going toilet training, attempting to achieve independence, and overall undergoing a transition from baby to child. Other stages are contemplated, such as pre-birth stages to illustrate experience of the baby while still in the womb. These stages are given by way of example only, as they can be further sub-divided, for example, into five stages or even more. Conversely, it can be consolidated into fewer that five stages. Older children, such as toddlers, might have more detailed stages associated with various aspects of their development.

While the stages of development have been described in relation to a child's ability to use certain feeding implements, it will be appreciated that stages may be defined with reference other types of baby care products. For a given type of baby care article, the stages of development associated therewith are dictated by the physical, physiological, emotional, mental, or other skills required to properly use or implement the article.

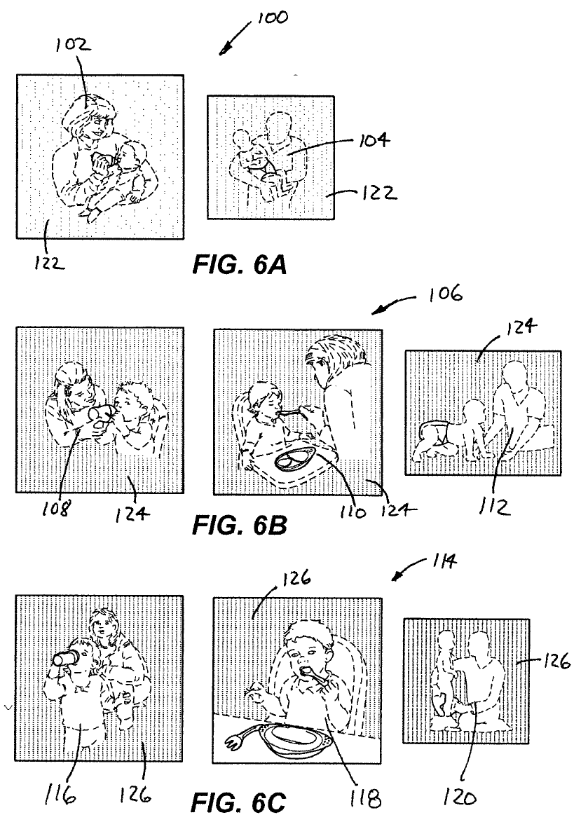

A coordinated system of marking baby care may be used to identify articles of different types as suitable for a specific stage of child development, thereby assisting a consumer in selecting products suitable for his or her child. The marking system may be applied to baby care articles from two or more sub-sets of baby care articles, which may be selected from a group of sub-sets including, but not limited to, diapers, wipes, bibs, feeding implements, bath care items, and personal hygiene products. The marking system uses similar pictorial representations on baby care articles from two or more sub-sets that are intended for use in the same or similar stage of development. Accordingly, a consumer may readily identify baby care articles of various types that are suitable for his or her own child. The marking system may include multiple arrays of pictorial representations, each of which is associated with a particular stage of development. Exemplary embodiments of such arrays are illustrated in FIGS. 6A, 6B, and 6C.

An array of pictorial representations may correspond to a first stage of development. As shown in FIG. 6A, a first array 100 includes pictorial representations 102, 104. The pictorial representation 102 is similar to that shown in FIG. 4A and shows a caregiver holding and feeding an infant with a baby bottle. Pictorial representation 104 shows a caregiver holding an infant that is wearing a diaper. In each of these pictorial representations 102, 104, the child is shown in a growing or pre-locomotive stage, in which the child is generally incapable of sitting on her own. As such, the caregiver is shown holding the child in an upright position. The first pictorial representation 102 of array 100 is suitable for use with a baby bottle, and therefore relates to the feeding implement sub-set of baby care articles. The second pictorial representation 104 of array 100 is suitable for use with a diaper, and therefore relates to the diaper sub-set of baby care articles.

An array of pictorial representations corresponding to a second stage of development is illustrated at FIG. 6B. A second array 106 includes a first pictorial representation 108, a second pictorial representation 110, and a third pictorial representation 112. The first pictorial representation 108 is similar to that shown in FIG. 4B and shows a caregiver handing a training cup to a child that is seated. The second pictorial representation 110 is similar to that shown in FIG. 5A and illustrates a caregiver feeding a child seated in a highchair. The third pictorial representation 112 shows a crawling child wearing a diaper with the caregiver providing assistance and encouragement. In each of these pictorial representations 108, 110, 112, the child is shown possessing at least a limited level of physical motor skills but is still receiving a significant amount of assistance from the caregiver. Accordingly, the consumer may identify the images of the children in these pictorial representations as being in a second stage of development that may correspond to a discovering stage. The first pictorial representation 108 of array 106 is suitable for use with a training cup while the second pictorial representation 110 of array 106 is suitable for use with a bowl and spoon, and therefore the pictorial representations 108, 110 relate to the feeding implement sub-set of baby care articles. The third pictorial representation 112 of array 106 is suitable for use with a diaper, and therefore relates to the diaper sub-set of baby care articles.

An array 114 of pictorial representations corresponding to a third stage of development is illustrated at FIG. 6C. The array 114 includes a first pictorial representation 116 similar to that of FIG. 4C showing a toddler drinking from a sippy cup while a caregiver observes from a distance. A second pictorial representation 118 is similar to that of FIG. 5B and shows a child seated at a table and using a training spoon, training fork, and training bowl, with no caregiver shown. A third pictorial representation 120 shows a caregiver placing a diaper on a standing child. The first pictorial representation 116 of array 114 is suitable for use with a sippy cup while the second pictorial representation 118 of array 114 is suitable for use with a training bowl, fork, and spoon, and therefore the pictorial representations 116, 118 relate to the feeding implement sub-set of baby care articles. The third pictorial representation 120 of array 106 is suitable for use with a diaper, and therefore relates to the diaper sub-set of baby care articles. Each pictorial representation in the array 114 shows a child having more advanced physical skills and coordination, while the caregiver takes a less active roll. The child in each pictorial representation 116, 118, 120 is in a third stage of development which may correspond to an exploring stage.

To assist a consumer in selecting baby care articles from different sub-sets that are appropriate for a particular stage of development, each pictorial representation in an array may incorporate a common visual element that is associated with that particular stage of development. The common visual element may be a graphic, a color, an image, or other indicia. In the first array 100, for example, each pictorial representation 102, 104, has a first background color 122. Similarly, the pictorial representations 108, 110, and 112 of the second array 106 all have a common second background color 124. Still further, the pictorial representations 116, 118, and 120 of the third array 114 all have a common third background color 126.

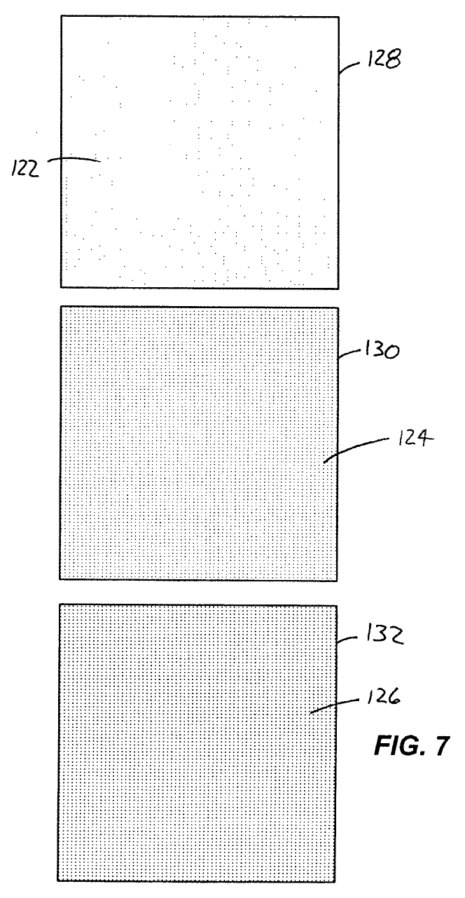

A legend showing how different background colors are indicated in the drawings is provided at FIG. 7. In general, dots of increasing size create increasingly darker shading. Accordingly, the legend includes a first background color swatch 128 having relatively small dots to create a relatively light shading, which indicates the first background color 122 associated with a first stage of development. A second background color swatch 130 shows intermediately sized dots to create an intermediate level of shading, which indicates the second background color 124 associated with the second stage of development. A third background color swatch 132 shows relatively large dots to create a darker shading, which indicates the third background color 126 associated with the third stage of development.

Alternatively or in addition to the background colors, the pictorial representations of each exemplary array may further include one or more common images to indicate suitability for use by a child in a particular stage of development. In the first array 100, for example, each pictorial representation 102, 104 further includes an image of a pre-locomotive child. The pictorial representations 102, 104 further include an image of a caregiver holding the child in an upright position. Both of these common images convey to a consumer a growing stage of development for which the baby care article is appropriate.

In the second array 106, pictorial representations 108, 110, 112 all include an image of a child having at least limited motor skills. Pictorial representations 108, 110 show a child capable of sitting on her own, while pictorial representation 112 shows a crawling child. Each pictorial representation 108, 110, 112 further includes an image of a caregiver position near the child and providing assistance. Accordingly, a consumer would understand that the products shown in the pictorial representations 108, 110, 112 are suitable for a child in an intermediate or discovering stage of development.

The third array 114 includes pictorial representations having images associated with a third stage of development. Pictorial representations 116, 118 include an image of a child feeding herself, while pictorial representation 120 includes an image of a child capable of standing. Accordingly, a consumer would understand the products shown in pictorial representations 116, 118, and 120 as being suitable for a child in a third or exploring stage of development.

The three arrays disclosed herein are provided as examples only. Additional arrays of pictorial representations corresponding to different or additional stages of development are contemplated. For example, while the exemplary embodiments have been described as associated with growing, discovering, and exploring stages, the stages may have different definitions or focus on other aspects of child development. Alternative stage definitions may include, but are not limited to, those listed above, which may or may not be related to the above-noted transition moments. Furthermore, while each array 100, 106, 114 includes pictorial representations relating to the feeding implement and diaper sub-sets of baby care articles, it will be appreciated that each array may include additional or different pictorial representations corresponding to additional or different sub-sets of baby care articles. In general, the baby care articles shown in the pictorial representations of a particular array may include two or more articles selected from a group of baby care article sub-sets including, but not limited to, diapers, wipes, bibs, feeding implements, bath care items, and personal hygiene products.

In view of the marking system disclosed herein, a method of assisting an identification of baby care articles appropriate for a particular baby are also disclosed. The method includes generating an array of pictorial representations including at least a first set of pictorial representations corresponding to a first stage of development and a second set of pictorial representations corresponding to a second stage of development. A first set of baby care articles adapted for use during the first stage of development is identified. The first set of baby care articles includes articles from at least two different baby care article sub-sets, which include diapers, wipes, bibs, feeding implements, bath care items, and personal hygiene products. A second set of baby care articles adapted for use during the second stage of development is also identified. The second set of baby care articles includes articles selected from at least two different baby care articles sub-sets selected from the group of baby care articles sub-sets noted above. The first set of baby care articles is marked with a pictorial representation selected from the first set of pictorial representations, while the second set of baby care articles is marked with a pictorial representation selected from the second set of pictorial representations. Accordingly, a consumer is more readily able to identify baby care articles intended for a particular stage of development, and therefore will be able to make more appropriate purchasing choices for his or her own child.

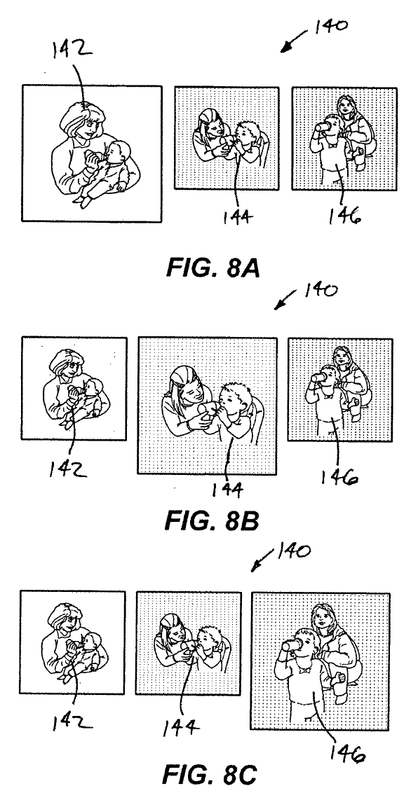

To assist a consumer in classifying his or her own child in the appropriate stage of development, each baby care article may have associated therewith pictorial representations corresponding to multiple stages of development. In FIG. 8A, for example, an array 140 of pictorial representations includes a first pictorial representation 142 corresponding to a first stage of development, a second pictorial representation 144 corresponding to a second stage of development, and a third pictorial representation 146 corresponding to a third stage of development. The array 140 may be shown on packaging associated with a baby care article. To identify the specific stage of development for which the baby care article is appropriate, the pictorial representation corresponding to that stage of development may be highlighted in some manner. For example, the first pictorial representation 142 may be larger than the second and third pictorial representations 144, 146, as shown in FIG. 8A. Alternatively, the second pictorial representation 144 or the third pictorial representation 146 may be larger than the other two pictorial representations, as illustrated in FIGS. 8B and 8C, respectively. Other methods of highlighting the desired pictorial representation in addition to using a larger size may be used, such as different shading or graphics.

The marking system disclosed herein assumes that the baby care articles from different sub-sets have at least two corresponding stages of development. While this is appropriate for the marking system and method, it should be noted that a stage of development identified for one type of baby care article need not have a corresponding stage of development in another type of baby care article. For example, the first baby stage of development identified for feeding implements may not have a counterpart stage of development identified with respect to the diapers, and vice versa.

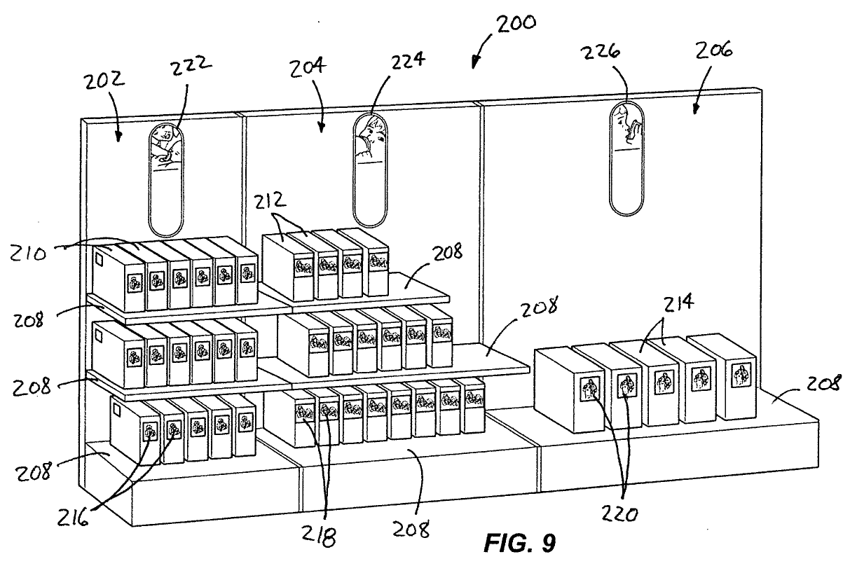

A retail display 200 may be provided quickly directs a consumer to baby care articles appropriate for his or her child. As illustrated in FIG. 9, the retail display 200 may include a first section 202, a second section 204, and a third section 206. Shelves 208 may be provided each section 202, 204, 206 suitable for carrying baby care articles. The first section 202 includes baby care articles 210 suitable for a child in a first stage of development. The second section 204 carries baby care articles 212 suitable for a second stage of development, while the third section 206 carries baby care articles suitable for a third stage of development. Each baby care article suitable for the first stage includes a pictorial representation 216 selected from a first set of pictorial representations associated with the first stage of development. Similarly, each baby care article 212 suitable for the second stage of development carries a pictorial representation 218 selected from a set of pictorial representations associated with the second stage of development. Still further, each baby care article for the third stage of development carries a pictorial representation 220 selected from a set of pictorial representations associated with the third stage of development.

The baby care articles 210, 212, 214 suitable for the first, second, and third stages of development may include products from various sub-sets of baby care articles including, but not limited to, diapers, wipes, bibs, feeding implements, bath care items, and personal hygiene products. While FIG. 9 illustrates the same pictorial representation on each article in a specific display section, it will be appreciated that the pictorial representations in a given display section may be different depending on the type of baby care article with which it is associated. For example, a first set of pictorial representations may correspond to the array 100 illustrated in FIG. 6A, and therefore will include a pictorial representation associated with a feeding implement and a pictorial representation associated with a diaper. The set may include additional or different pictorial representations associated with different sub-sets of baby care articles. Each pictorial representation of a given set includes a common visual element that identifies the pictorial representation as a member of the set. The common visual element may be background color, image, or other graphic feature, as described in greater detail above.

Each display section further includes a display pictorial representation identifying the stage of development for which the products carried by that section are appropriate, thereby quickly directing a consumer to the display section carrying baby care articles suitable for the desired stage of development. In the exemplary embodiment illustrated at FIG. 9, the first display section 202 includes a pictorial representation 222 selected from the first set of pictorial representations associated with a first stage of development. Similarly, the second display section 204 includes a second pictorial representation 224 selected from the second set of pictorial representations associated with the second stage of development, while the third display section 206 includes a third pictorial representation 226 selected from a third set of pictorial representations associated with the third stage of development. As a result, a consumer can view the pictorial representations 222, 224, 226 associated with the sections 202, 204, 206 and either positively identify the desired section or disregard one or more sections that are not associated with the desired stage of development. The pictorial representations 222, 224, 226 provided with the display may include visual elements that are common with the pictorial representations 216, 218, 220 provided on the baby care articles.

A method of displaying baby care articles which facilitates quick and accurate selections by a consumer is also provided. The method includes generating a first set of pictorial representations corresponding to a first baby stage of development and a second set of pictorial representations corresponding to a second baby stage of development. A first set of baby care articles appropriate for the first stage of development is located in a first display section, wherein the first set of baby care articles includes articles selected from at least two baby care article sub-sets. A second set of baby care articles appropriate for the second baby stage of development is located in a second display section. The second set of baby care articles includes articles from at least two different baby care articles sub-sets. As noted above, the baby care articles sub-sets may be selected from a group of sub-sets comprising diapers, wipes, bibs, feeding implements, bath care items, and personal hygiene products. The first display section is marked with a first display pictorial representation selected from the first set of pictorial representations, while the second display section is marked with a second display pictorial representation selected from the second set of pictorial representations. The method may further include generating a third set of pictorial representations corresponding to a third baby stage of development and a third set of baby care articles appropriate for the third baby stage of development located in a third display section, wherein the third display section is marked with a third display pictorial representation selected from the third set of pictorial representations.

All documents cited in the Detailed Description of the Invention are, in relevant part, incorporated herein by reference, the citation of any document is not to be construed as an admission that it is prior art with respect to the present invention.

While particular embodiments of the present disclosure have been illustrated and described, it would be obvious to those skilled in the art that various other changes and modifications can be made without departing from the spirit and scope of the invention. It is therefore, intended to cover in the appended claims all such changes and modifications that are within the scope of this disclosure.

What is claimed is:

1. An array of feeding implement products, the array comprising:
a first feeding implement adapted for use during a first stage of development;
a first package enclosing the first feeding implement;
a first pictorial representation disposed on the first package, the first pictorial representation depicting the first feeding implement, a caregiver, and a first baby, wherein the first baby is represented as corresponding to the first stage of development;
a second feeding implement adapted for use during a second stage of development;
a second package enclosing the second feeding implement; and
a second pictorial representation disposed on the second package, the second pictorial representation depicting the second feeding implement, a caregiver, and a second baby, wherein the second baby is represented as corresponding to the second stage of development.

2. The array of claim 1 further comprising a third feeding implement adapted for use during a third stage of development, a third package enclosing the third feeding implement, and a third pictorial representation disposed on the third package, the third pictorial representation depicting the third feeding implement, a caregiver, and a third baby, wherein the third baby is represented as corresponding to the third stage of development.

3. The array of claim 2, in which the first stage of development comprises a growing stage.

4. The array of claim 3, in which the second stage of development comprises a discovering stage.

5. The array of claim 4, in which the third stage of development comprises an exploring stage.

6. The array of claim 2, in which the first feeding implement comprises a bottle with a nipple.

7. The array of claim 6, in which the second feeding implement comprises a training cup.

8. The array of claim 6, in which the second feeding implement comprises a bowl and spoon.

9. The array of claim 6, in which the third feeding implement comprises a sippy cup.

10. The array of claim 6, in which the third feeding implement comprises a training plate, a training spoon, and a training fork.

11. A line of feeding implements suitable for use by children in at least a first stage of development and a second stage of development, the line of feeding implements comprising:
a first feeding implement adapted for use during the first stage of development;
a second feeding implement adapted for use during the second stage of development;
a first pictorial representation associated with the first feeding implement including an image of the first feeding implement and an image of a first child, wherein the first child is represented as corresponding to the first stage of development; and
a second pictorial representation associated with the second feeding implement including an image of the second feeding implement and an image of a second child, wherein the second child is represented as corresponding to the second stage of development.

12. The line of feeding implements of claim 11, in which the first feeding implement is disposed in a first package and the first pictorial representation is formed on a second label attached to the first package.

13. The line of feeding implements of claim 12, in which the second feeding implement is disposed in a second package and the second pictorial representation is formed on a second label attached to the second package.

14. The line of feeding implements of claim 11, in which the line further includes feeding implements suitable for use by children in a third stage of development, the line further comprising a third feeding implement adapted for use during the third stage of development and a third pictorial representation associated with the third feeding implement including an image of the third feeding implement and an image of a third child, wherein the third child is represented as corresponding to the third stage of development.

15. The line of feeding implements of claim 11, in which the first pictorial representation further includes an image of a caregiver assisting the child with the first feeding implement.

16. The line of feeding implements of claim 11, in which the first pictorial representation further includes a first background color and the second pictorial representation further includes a second background color.
